(19) United States
(12) Patent Application Publication
(10) Pub. No.: US 2016/0170628 A1
(43) Pub. Date: Jun. 16, 2016

(54) VISUAL EFFECTS FOR SCIENTIFIC WORKFLOW EDITORS

(71) Applicant: Biodatomics, LLC, Bethesda, MD (US)

(72) Inventor: Maxim Mikheev, Elkridge, MD (US)

(21) Appl. No.: 15/053,332

(22) Filed: Feb. 25, 2016

Related U.S. Application Data
(63) Continuation of application No. 14/099,884, filed on Dec. 6, 2013, now abandoned.

(51) Int. Cl. G06F 3/0484

(52) U.S. Cl. CPC G06F 3/04847

(57) ABSTRACT

Provided are methods and systems for the visualization of elements of a scientific workflow. A method for visualization of elements of a scientific workflow may include displaying the scientific workflow via a user interface. Based on predetermined grouping criteria, one or more collapsible groups of elements are defined within the scientific workflow. Upon receiving a request to collapse the collapsible groups of elements, the collapsible groups of elements are collapsed into collapsed groups of elements. After collapsing, a layout of the plurality of elements and the collapsed groups of elements is selectively readjusted. The method can further include adding further elements to the scientific workflow, removing elements from the scientific workflow, and modifying elements in the scientific workflow.

### TECHNICAL FIELD

This disclosure relates generally to data processing and, more specifically, to scientific workflow visualization.

### BACKGROUND

The approaches described in this section could be pursued but are not necessarily approaches that have previously been conceived or pursued. Therefore, unless otherwise indicated, it should not be assumed that any of the approaches described in this section qualify as prior art merely by virtue of their inclusion in this section.

A traditional workflow management system can manage and define a series of tasks within a project to produce a final result. Workflow management systems can allow defining different workflows for different types of tasks or processes. Furthermore, workflow management systems can assist a user in development of complex applications at a higher level by orchestrating functional components without handling the implementation details. At each stage in the workflow, one or more executable software modules may be responsible for a specific task. Once the task is complete, the workflow software can ensure that the next task is executed by the modules responsible for the next stage of the process. The workflow management system can reflect the dependencies required for the completion of each task. In general, the workflow management system can control automated processes by automating redundant tasks and ensuring that uncompleted tasks are followed up on.

The workflow management system can be developed in a specialized form for specific needs. Specifically, a scientific workflow management system can be designed to compose and execute a series of computational and data processing operations for a scientific application. An example of a scientific workflow management system is a bioinformatics workflow management system. Bioinformatics can be defined as an interdisciplinary field that develops and improves on methods for storing, retrieving, organizing and analyzing biological data. A major activity in bioinformatics is to develop software tools to generate useful biological knowledge. However, it should be understood that applications of the technology disclosed here are not necessarily limited to bioinformatics.

Since scientific workflows may differ from traditional business process workflows, the scientific workflow management system can enable scientists to perform specific steps. For example, interactive tools can be provided to enable scientists to execute scientific workflows and to view results interactively. Additionally, scientists may be able to track the source of the scientific workflow execution results and the steps used to create the workflow.

Scientists are developing more and more complex workflows to manage and process large data sets and to execute scientific experiments. Consequently, visualization of the workflows in the workflow management systems becomes correspondingly complex, often obstructing visual perception and editability of the workflow for a workflow developer. As a result, developing and editing workflows by workflow developers can be time and effort consuming. Furthermore, available workflows are restricted to specific types of applications and their adaptation for scientific purposes can be difficult.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

The present disclosure is related to approaches for visualization of elements of a scientific workflow. Specifically, a method for visualization of elements of a scientific workflow comprises displaying the scientific workflow via a user interface. Based on predetermined grouping criteria, one or more collapsible groups of elements are defined within the scientific workflow. Upon receiving a request to collapse the collapsible groups of elements, the collapsible groups of elements are collapsed into collapsed groups of elements. After the collapsing, a layout of the plurality of elements and the collapsed groups of elements can be selectively readjusted. The method further comprises adding further elements to the scientific workflow, removing elements from the scientific workflow, and modifying elements in the scientific workflow.

According to another approach of the present disclosure, there is provided a system for visualization of elements of a scientific workflow. The system comprises a processor configured to define collapsible groups of elements within the scientific workflow. The defining can be made based on predetermined grouping criteria. Upon receiving from a user a request to collapse the collapsible groups of elements, the processor can collapse the collapsible groups of elements into collapsed groups of elements. The processor is further configured to selectively readjust a layout of the plurality of elements and the collapsed groups of elements. The system further comprises a user interface configured to display the scientific workflow that includes a plurality of elements.

In further example embodiments of the present disclosure, the method steps are stored on a machine-readable medium comprising instructions, which when implemented by one or more processors perform the recited steps. In yet further example embodiments, hardware systems or devices can be adapted to perform the recited steps. Other features, examples, and embodiments are described below.

### BRIEF DESCRIPTION OF THE DRAWINGS

Embodiments are illustrated by way of example, and not by limitation, in the figures of the accompanying drawings, in which like references indicate similar elements and in which:

FIG. 1 shows an environment within which a system for visualization of elements of a scientific workflow and associated methods can be implemented, according to example embodiments.

FIG. 2 is a process flow diagram showing a method for visualization of elements of a scientific workflow, according to an example embodiment.

FIG. 3 is a block diagram showing various modules of a system for visualization of elements of a scientific workflow, according to an example embodiment.

FIG. 4 is a block diagram illustrating a collapsed workflow, according to an example embodiment.

FIG. 5 is a block diagram illustrating a partially collapsed workflow, according to an example embodiment.

FIG. 6 is a scheme illustrating a partially collapsed workflow, according to an example embodiment.

FIGS. 7A-C illustrate an expanded workflow, according to an example embodiment.

FIG. 8 shows a diagrammatic representation of a computing device for a machine in the example electronic form of a computer system, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is therefore not to be taken in a limiting sense, and the scope is defined by the appended claims and their equivalents. In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The techniques of the embodiments disclosed herein can be implemented using a variety of technologies. For example, the methods described herein can be implemented in software executing on a computer system or in hardware utilizing either a combination of microprocessors or other specifically designed integrated circuits (ASICs), programmable logic devices, or various combinations thereof. In particular, the methods described herein may be implemented by a series of computer-executable instructions residing on a storage medium, such as a disk drive, or a computer-readable medium. It should be noted that methods disclosed herein can be implemented by a mobile terminal, a smart phone, a computer (e.g., a desktop computer, a tablet computer, a laptop computer), and so forth.

The present disclosure relates to systems and methods for providing scientific workflow editors with improved visualization and for improving the usability of scientific workflows by developers. Specifically, embodiments described herein include methods for the visualization of elements of scientific workflows. An example scientific workflow can include multiple elements. The elements can include loops, conditional statements, markers, algorithms, nested workflows, tools, such as computational tools, and so forth. The elements of the scientific workflow can be represented in a layout of the scientific workflow. The layout can have a specific arrangement, sizing, spacing, and placement of the elements of the scientific workflow shown on a user interface. In case of a complex management system for scientific workflows with a great number of elements, it may be difficult for a user, e.g. a workflow developer, to see the functionality of each element. The method disclosed herein can provide improved editability of the scientific workflow; enable adding new elements to the layout, connecting elements together, removing elements, hiding elements, reordering the elements automatically, and so forth. The method disclosed here can be implemented by an event-driven management engine which can enable scientists in the fields of science such as, for example, biology, bionomics, and bioinformatics, to query and analyze sequence data using a number of informatics tools and save the results.

According to the present disclosure, elements of the layout can be ordered into groups. These groups can be collapsed into a single element representing the group. Similarly, the collapsed group can be expanded to show the constituent elements. Furthermore, the user can be allowed to connect several elements in the layout of the scientific workflow to define a collapsible group. The group can be increased in size to show which elements are included in the group. When a user needs to access a particular element of the group, the user can expand the combined element and select the specific element.

Furthermore, in an example embodiment, the user can use markers for some elements of the scientific workflow. The user can arrange several elements into a block and mark the block with the markers. The marked block can be smaller compared to the initial size of the block. In an example embodiment, the marker can show that the marked element is in a collapsed state and can be expanded, that the block is removed from the layout, and so forth. Furthermore, the user may provide a name for the block or mark the block with a symbol. The name can describe the elements included in the block. When the user needs to use a particular element hidden in a collapsed block, the user can get information on the collapsed block by reading the name, and if needed, expand the block. After expanding the block, all elements of the block can be shown and the user can select specific elements. Furthermore, where several elements of the scientific workflow can be used in a similar way, the user can create algorithms to use these elements as a group. These elements can be connected into a single block and named according to their common functionality.

Furthermore, the scientific workflow editor of the present disclosure provides for self-positioning of the elements in the layout to optimize the position of the elements in the layout for better visualization. Therefore, the elements may be positioned in the layout in such a way as to avoid unused portions of the layout between the elements of the scientific workflow.

Collapsing and expanding the elements of the scientific workflow can be especially helpful to demonstrate nested workflows. Nested workflows are workflows inside a main workflow. The nested workflows can include elements. A scientific workflow can include any number of nested workflows, and each of the nested workflows, in turn, can include further nested workflows. A nested workflow can be collapsed or expanded within the main workflow. The nested workflow can be marked with a specific marker.

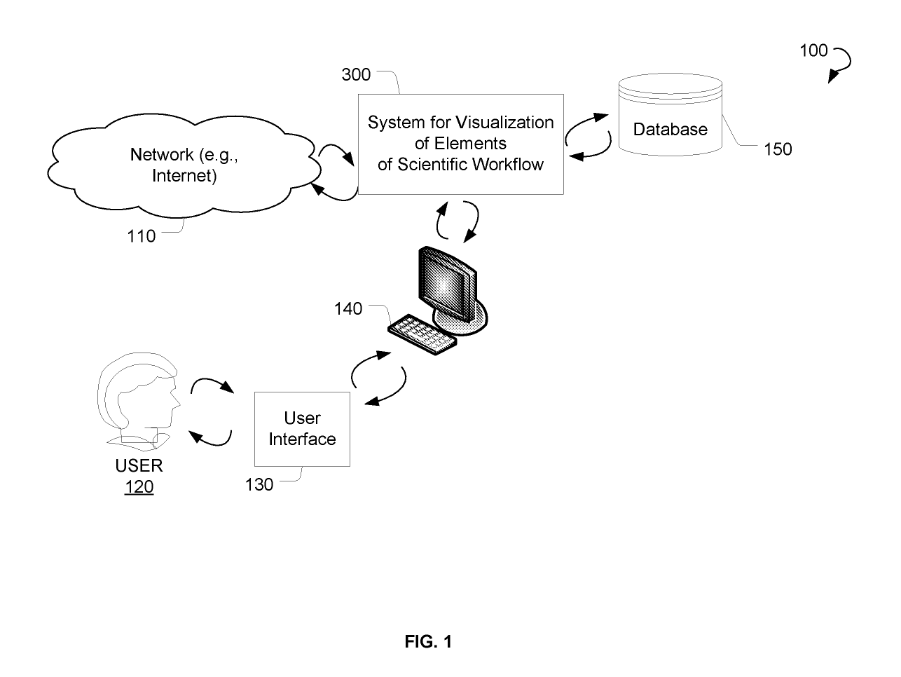

Referring now to the drawings, FIG. 1 illustrates an environment 100 within which a method for visualization of elements of a scientific workflow and a system can be implemented. The environment 100 may include a network 110, a user 120, a system 300 for visualization of elements of a scientific workflow, a user interface 130, one or more client devices 140, and a database 150.

The network 110 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. The network 110 may include a network of data processing nodes that are interconnected for the purpose of data communication. The network 110 may include a Software-defined Networking (SDN). The SDN may include one or more of the above network types. Generally the network 110 may include a number of similar or dissimilar devices connected together by a transport medium enabling communication between the devices by using a predefined protocol. Those skilled in the art will recognize that the present disclosure may be practiced within a variety of network configuration environments and on a variety of computing devices.

The client device 140, in some example embodiments, may include a Graphical User Interface (GUI) for displaying the user interface 130. In a typical GUI, instead of offering only text menus or requiring typed commands, the user interface 130 may present graphical icons, visual indicators, or special graphical elements called widgets. The user interface 130 may be utilized as a visual front-end to allow the user 120 to build and modify scientific workflows with little or no programming expertise.

The client device 140 may include a mobile telephone, a computer, a lap top, a smart phone, a tablet personal computer (PC), and so forth. In some embodiments, the client device 140 may be associated with one or more users 120. The client device 140 may be configured to utilize icons used in conjunction with text, labels, or text navigation to fully represent the information and actions available to the user 120. The user 120, in some example embodiments, may be a person interacting with the user interface 130 via one of the client devices 140. The user 120 may represent a person that uses the system 300 for visualization of elements of a scientific workflow for his or her needs. For example, the user 120 may include a scientist using the system 300 for visualization of the elements of the scientific workflow for performing a series of computational or data manipulation steps. As shown on FIG. 1, the user 120 may input data to an application running on the client device 140. The application may utilize the system 300 for visualization of the elements of the scientific workflow. Based on the input of the user 120, the system 300 for visualization of the elements of the scientific workflow may visualize the scientific workflow of the application running on the client device 140. The system 300 for visualization of the elements of the scientific workflow may be connected to one or more databases 150. The databases 150 may store data associated with tasks that need to be executed in the course of the scientific workflow, rules associated with positioning workflow elements on a layout of the scientific workflow, and so forth.

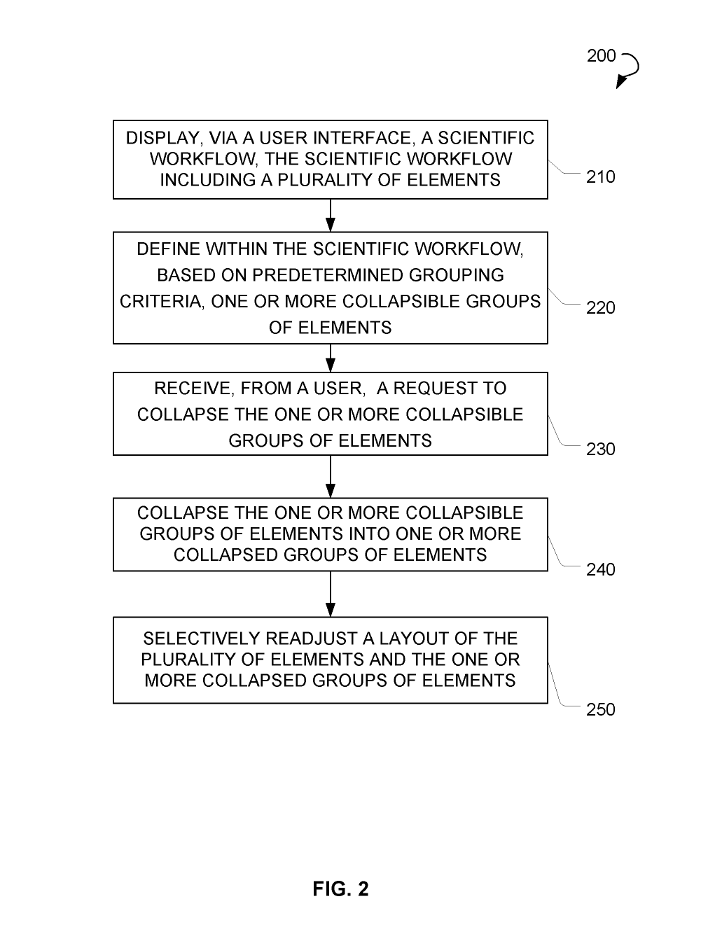

FIG. 2 is a process flow diagram showing a computer-implemented method 200 for visualization of elements of a scientific workflow, according to an example embodiment. The method 200 may be performed by processing logic that may comprise hardware (e.g., decision making logic, dedicated logic, programmable logic, and microcode), software (such as software running on a general-purpose computer system or a dedicated machine), or a combination of both.

The method 200 commences with displaying, via a user interface, the scientific workflow at operation 210. The scientific workflow includes a plurality of elements, such as a word, an idea, a task, and so forth. The elements may be shown on the user interface in a form of blocks. Connections between elements may be shown as connections between the blocks. At operation 220, the method comprises defining one or more collapsible groups of elements within the scientific workflow. The defining is made based on predetermined grouping criteria. The one or more collapsible groups of elements include one or more of a loop, a conditional statement, a computational tool, a marker, an algorithm, a nested workflow, and so forth.

At operation 230, a request to collapse the one or more collapsible groups of elements is received from a user. After receiving the request, the one or more collapsible groups of elements is collapsed into one or more collapsed groups of elements at operation 240.

After collapsing of the one or more collapsible groups of elements, at operation 250, a layout of the plurality of elements and the one or more collapsed groups of elements is selectively readjusted. A block depicting the collapsed group of elements on the layout may be of a greater size than the blocks of the collapsible group of elements.

In an example embodiment, the method 200 further comprises receiving, from the user, a request to expand the one or more collapsed groups of elements formed at operation 240. In response to the request, the collapsed group of elements is expanded into the one or more groups of elements. After expanding the groups of elements, the layout of the scientific workflow is selectively readjusted.

In an example embodiment, the method 200 optionally comprises receiving a request from the user to add a further element to the scientific workflow. In response to the request, the further element is added to the scientific workflow and the layout of the scientific workflow is selectively readjusted.

In an example embodiment, the method 200 optionally comprises receiving a request from the user to remove a further element from the scientific workflow. In response to the request, the further element is removed from the scientific workflow and the layout of the scientific workflow is selectively readjusted.

In a further example embodiment, the method 200 optionally comprises receiving a request from the user to modify a further element of the scientific workflow. In response to the request, the further element of the scientific workflow is modified and the layout of the scientific workflow is selectively readjusted.

In some example embodiments, the method 200 comprises adding a space saving element to the layout of the scientific workflow. The space saving element is configured to reorder the arrangement of the elements of the scientific workflow to optimize the arrangement of the elements on the layout. In some embodiments, the reordering takes place automatically. That is, each element of the scientific workflow is self-positioned in response to receiving user requests to collapse the collapsible groups of elements, to expand the collapsed groups of elements, to add further elements to the scientific workflow, and the like.

In an example embodiment, the method 200 comprises receiving a request to create a visualization of an element or a group of elements of the scientific workflow. The visualization allows the user to edit the element or the group of elements while working on the scientific workflow. In response to the request, the visualization of the element or the group of elements of the scientific workflow is created.

In an example embodiment, the visualization comprises an inline editor. The inline editor allows users to dynamically edit elements shown via the user interface. The inline editor enables the user to create markers of the elements of the scientific workflow and depict the markers as an expandable block. The marker may include a description of the element included in the expandable block. After creation of the markers, the markers are depicted on the layout.

When the user needs to execute the elements of the block marked by the marker, the user gives a request to expand the expandable block marked by the marker. In response to the request, the expandable block expands and the user selects the needed element of the scientific workflow. The user may select several markers, the elements of which are to be executed in the scientific workflow. In such a case, the elements of the unselected markers are not executed during the scientific workflow.

Furthermore, in an example embodiment, the user creates an algorithm for a selected group of elements of the scientific workflow and marks the selected group of elements with a marker describing the algorithm. All elements of the selected group of elements are executed using the algorithm created by the user.

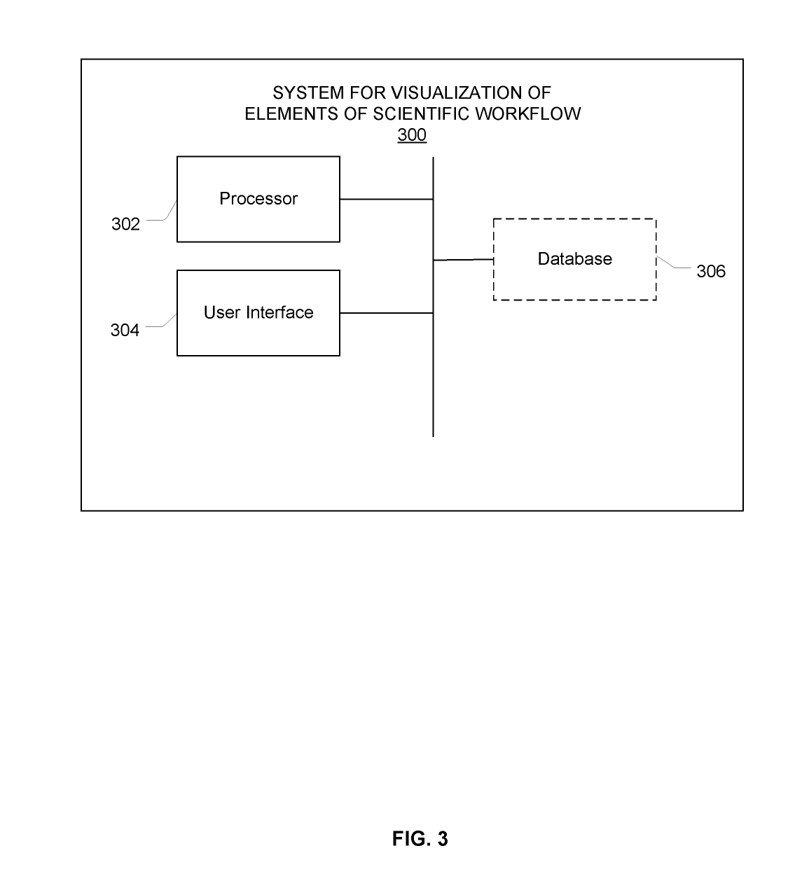

FIG. 3 shows a detailed block diagram of a system 300 for visualization of elements of a scientific workflow, in accordance with an example embodiment. The system 300 may include a processor 302, a user interface 304, and, optionally, a database 306.

In an example embodiment, the processor 302 is configured to define, based on predetermined grouping criteria, one or more collapsible groups of elements within the scientific workflow. Furthermore, the processor 302 is configured to receive, from a user, a request to collapse the one or more collapsible groups of elements. In response to the request, the processor 302 is configured to collapse the one or more collapsible groups of elements into one or more collapsed groups of elements. The one or more collapsible groups of elements include a loop, a conditional statement, a computational tool, a marker, an algorithm, a nested workflow, and so forth. After collapsing the one or more collapsible groups of elements, the processor selectively readjusts a layout of the plurality of elements and the one or more collapsed groups of elements.

In an example embodiment, the processor 302 is further configured to receive a request to add a further element to the scientific workflow. In response to the request, the processor 302 adds the further element to the scientific workflow and selectively readjusts the layout of the scientific workflow. In a further example embodiment, the processor 302 is further configured to receive a request to remove a further element from the scientific workflow. In response to the request, the processor 302 removes the further element from the scientific workflow and selectively readjusts the layout of the scientific workflow. In an example embodiment, the processor 302 is further configured to receive a request to modify a further element of the scientific workflow. In response to the request, the processor 302 modifies the further element to the scientific workflow and selectively readjusts the layout of the scientific workflow.

In a further example embodiment, the processor 302 is configured to add a space saving element to the layout of the scientific workflow. The space saving element is configured to reorder the arrangement of the elements of the scientific workflow to optimize the arrangement of the elements on the layout.

In a further example embodiment, the processor 302 is configured to receive a request to create a visualization of an element or a group of elements of the scientific workflow. The visualization allows the user to edit the element or the group of elements while working on the scientific workflow. In response to the request, the processor 302 creates the visualization of the element or the group of elements of the scientific workflow. In an example embodiment, the visualization comprises an inline editor.

The user interface 304 of the system 300 is configured to display the scientific workflow. The scientific workflow includes a plurality of elements. The plurality of elements includes a word, an idea, a task, and the like. In an example embodiment, the user interface 304 depicts the elements of the scientific workflow as blocks. Connections between the elements of the scientific workflow are depicted as connections between the blocks.

The databases 306 stores data associated with the scientific workflow, such as tasks that need to be executed in the course of the scientific workflow, rules associated with positioning workflow elements on a layout of the scientific workflow, and so forth.

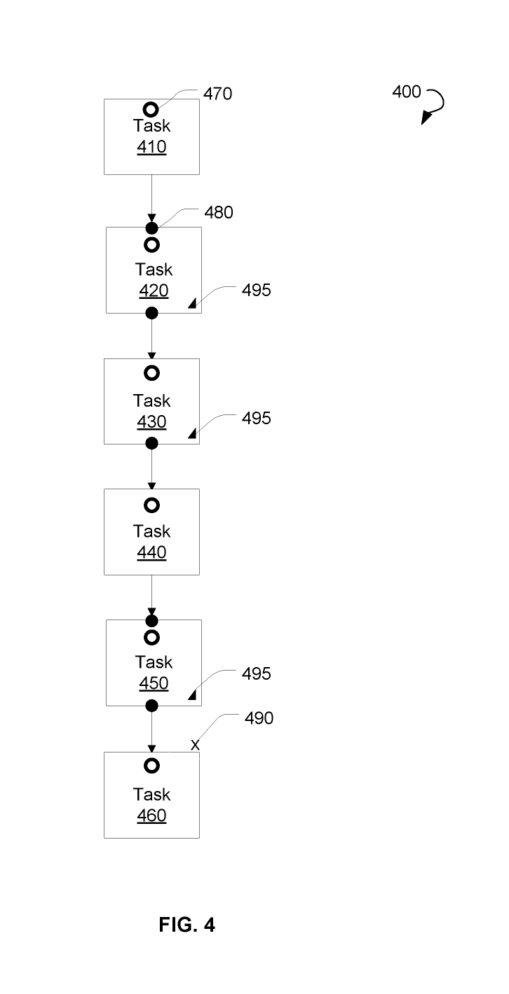

FIG. 4 shows a scheme 400 for a scientific workflow in a collapsed form. The scientific workflow comprises tasks 410-460. Each task is shown in a separate block. The blocks of the tasks 410-460 comprise markers 470, 480, 490, 495. The markers 470, 480, 490, 495 show actions available to be done on the tasks 410-460. For example, the task 460 may be removed or hidden from the layout of the scientific workflow by using the marker 490. The tasks 420, 430, 450 may be expanded by using the markers 495. The markers 470, 480 may represent any information relevant to the tasks 410-460, such as ability of the task to be expanded, obligatory task of the scientific workflow, optional task of the scientific workflow, and the like.

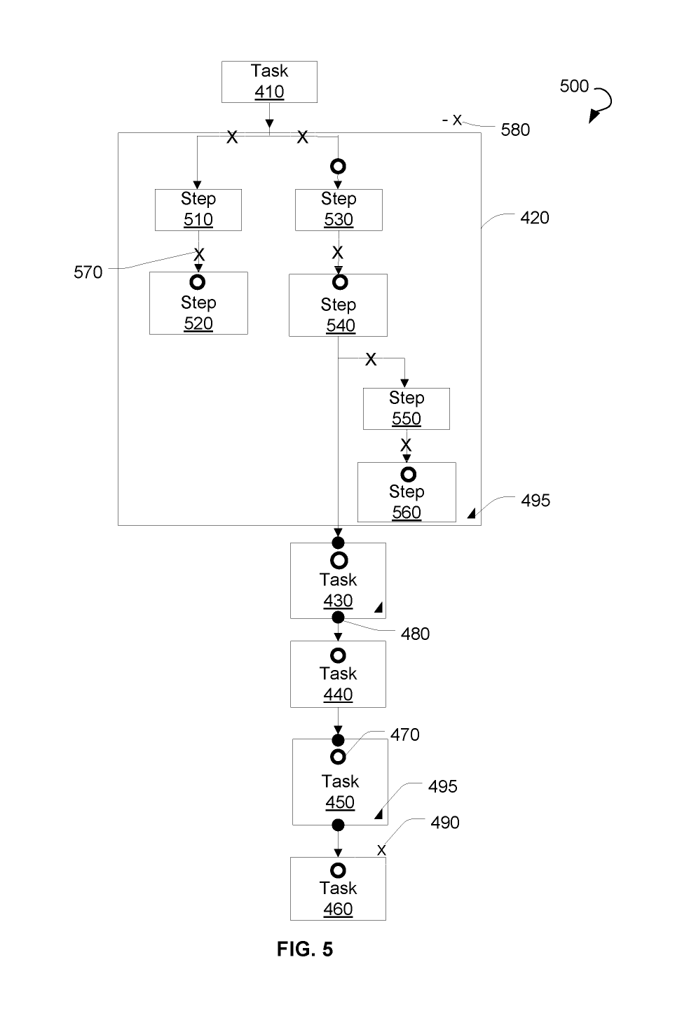

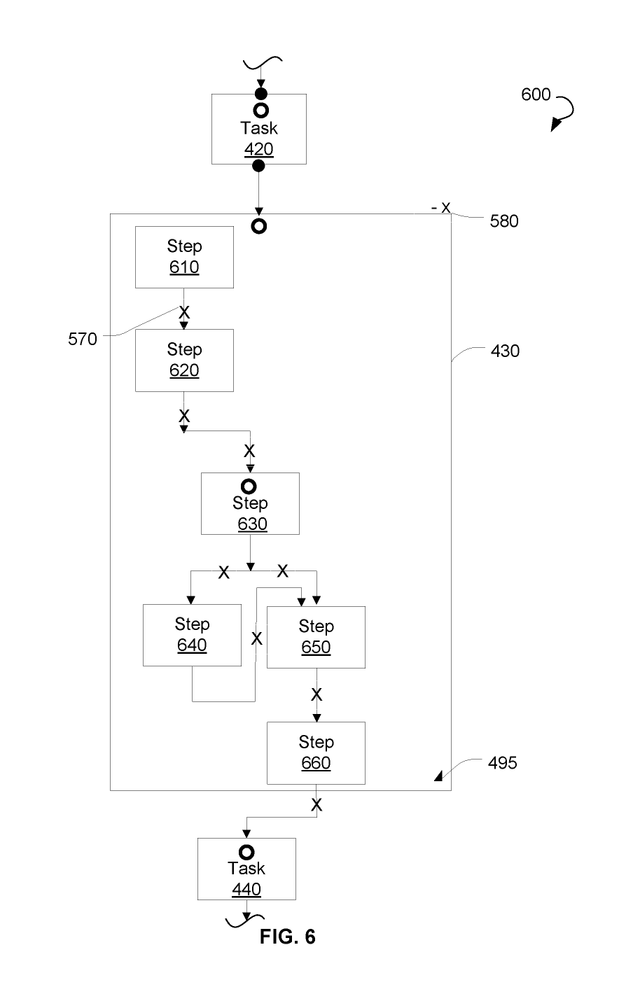

FIG. 5 shows a scheme 500 for the collapsed workflow of FIG. 4, in which the task 420 is expanded. The task 420 comprises several steps shown as steps 510-560. The expanded task 420 may be collapsed to the initial form using the marker 495. The markers 570 are used to remove the steps 510-560 from the task 420. The marker 580 is used to close the task 420.

FIG. 6 shows a scheme 600 for the collapsed workflow of FIG. 4, in which the task 430 is expanded. For clear illustration, tasks 410, 450, 460 are not shown on FIG. 6. The task 430 comprises several steps shows as steps 610-660. The expanded task 430 may be collapsed to the initial form using the marker 495. The marker 580 is used to close the task 430. The markers 570 are used to remove the steps 610-660 from the task 430 or to remove the task 440 from the scientific workflow.

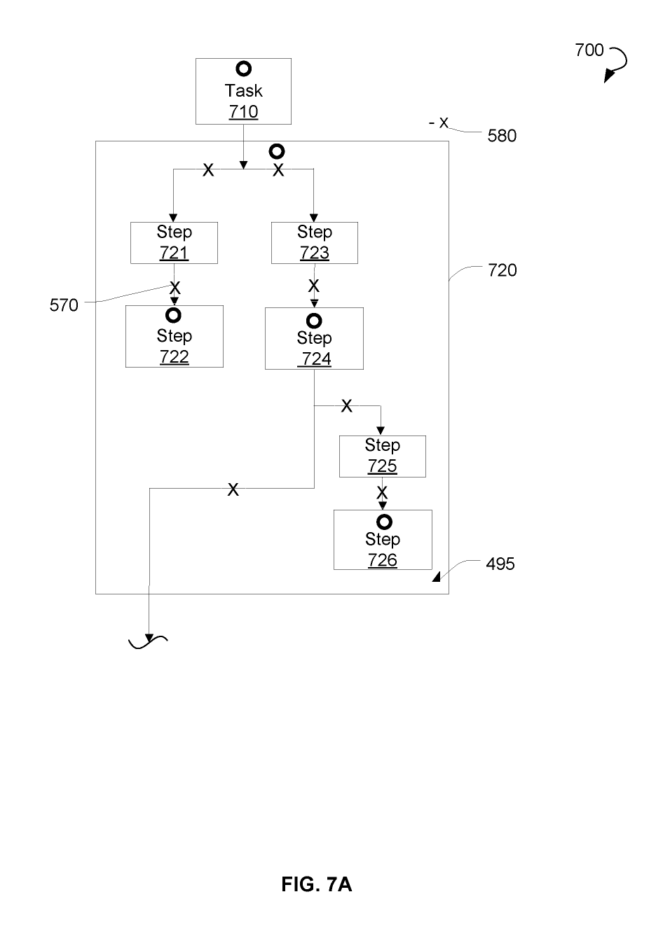

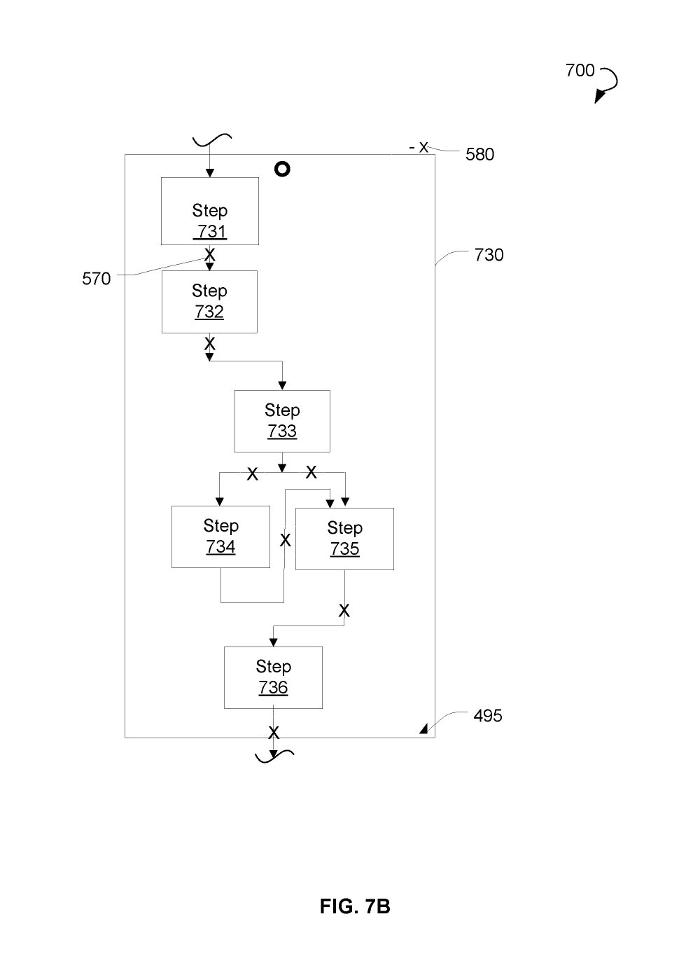

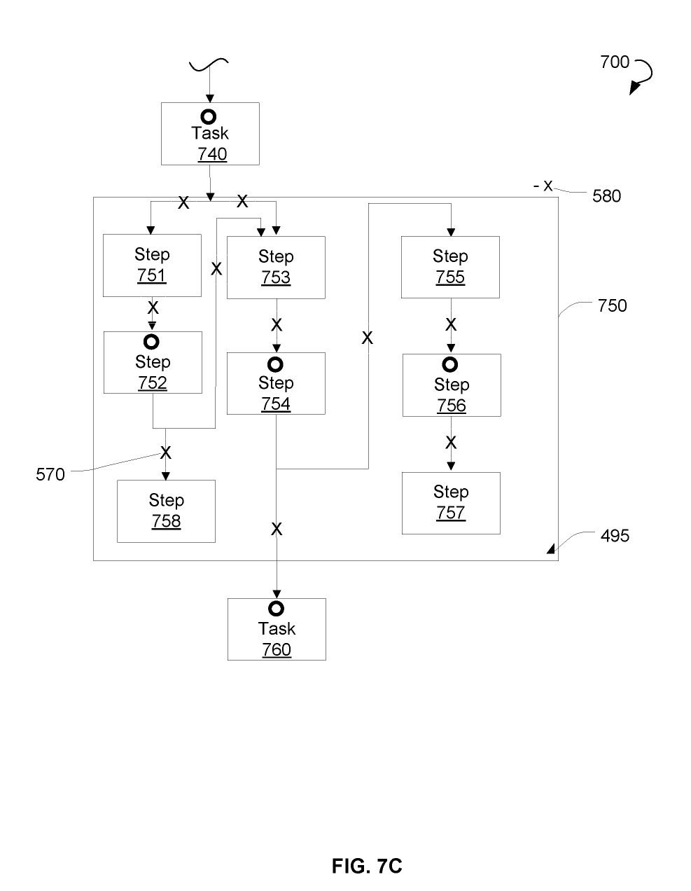

FIGS. 7A-7C show a scheme 700 for a scientific workflow of FIG. 4 in an expanded form. In particular, as shown on FIG. 7A, the task 710 is non-expandable. Task 720 is expanded and comprises steps 721-726. The markers 570 are used to remove any of steps 721-726 from the task 720. The expanded task 720 may be collapsed to the initial form using the marker 495. The marker 580 is used to close the task 720.

FIG. 7B shows the task 730 in an expanded form. Task 730 is expanded and comprises steps 731-736. The marker 495 may be used to collapse the task 730. The markers 570 are used to remove any of steps 731-736 from the task 730. The marker 580 is used to close the task 730.

As shown on FIG. 7C, the tasks 740 and 760 are non-expandable. The task 750 is expanded and comprises steps 751-757. The marker 495 is used to collapse the task 750. The markers 570 are used to remove any of steps 751-757 from the task 750. The marker 580 is used to close the task 750.

The tasks 720, 730, 750 represent nested workflows comprised in the scientific workflow shown on FIGS. 7A-7C. Specifically, the tasks 720, 730, 750 are workflows that are executed during running of the scientific workflow shown on FIGS. 7A-7C.

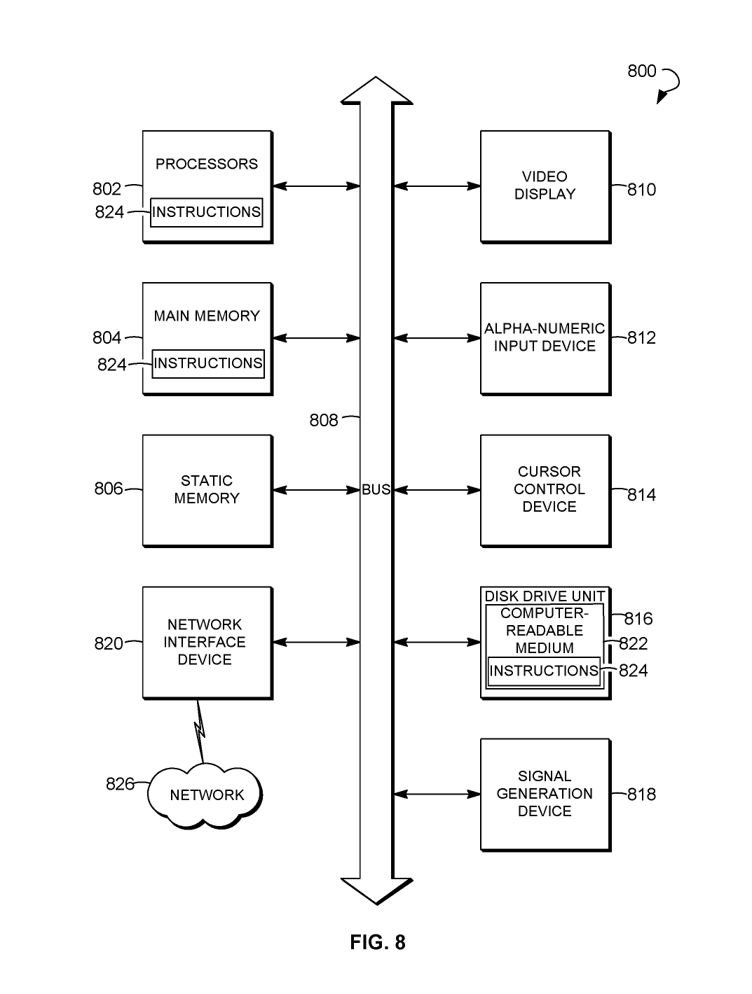

FIG. 8 shows a diagrammatic representation of a machine in the example electronic form of a computer system 800, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a PC, a tablet PC, a set-top box (STB), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor or multiple processors 802 (e.g., a central processing unit (CPU), a graphics processing unit (GPU), or both), a main memory 804, and a static memory 806, which communicate with each other via a bus 808. The computer system 800 may further include a video display unit 810 (e.g., a liquid crystal display (LCD) or a cathode ray tube (CRT)). The computer system 800 may also include an alphanumeric input device 812 (e.g., a keyboard), a cursor control device 814 (e.g., a mouse), a disk drive unit 816, a signal generation device 818 (e.g., a speaker), and a network interface device 820.

The disk drive unit 816 includes a non-transitory computer-readable medium 822, on which is stored one or more sets of instructions and data structures (e.g., instructions 824) embodying or utilized by any one or more of the methodologies or functions described herein. The instructions 824 may also reside, completely or at least partially, within the main memory 804 and/or within the processors 802 during execution thereof by the computer system 800. The main memory 804 and the processors 802 may also constitute machine-readable media.

The instructions 824 may further be transmitted or received over a network 826 via the network interface device 820 utilizing any one of a number of well-known transfer protocols (e.g., Hyper Text Transfer Protocol (HTTP)).

While the computer-readable medium 822 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

Thus, methods and systems for visualization of elements of a scientific workflow are disclosed. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A method for visualization of elements of a scientific workflow, the method comprising:
displaying, via a user interface, the scientific workflow, the scientific workflow including a plurality of elements;
defining within the scientific workflow, based on predetermined grouping criteria, one or more collapsible groups of elements;
receiving, from a user, a request to collapse the one or more collapsible groups of elements;
collapsing the one or more collapsible groups of elements into one or more collapsed groups of elements; and
selectively readjusting a layout of the plurality of elements and the one or more collapsed groups of elements.

2. The method of claim 1, further comprising:
receiving a request to add a further element to the scientific workflow;
adding the further element to the scientific workflow; and
selectively readjusting the layout of the scientific workflow.

3. The method of claim 1, further comprising:
receiving a request to remove a further element from the scientific workflow;
removing the further element from the scientific workflow; and
selectively readjusting the layout of the scientific workflow.

4. The method of claim 1, further comprising:
receiving a request to modify a further element of the scientific workflow;
modifying the further element of the scientific workflow; and
selectively readjusting the layout of the scientific workflow.

5. The method of claim 1, wherein the one or more collapsible groups of elements include one or more of a loop, a conditional statement, a computational tool, a marker, an algorithm, and a nested workflow.

6. The method of claim 1, wherein the plurality of elements comprises one or more of a word, an idea, and a task.

7. The method of claim 1, further comprising adding a space saving element to the layout of the scientific workflow.

8. The method of claim 1, further comprising:
receiving a request to create a visualization of an element or a group of elements of the scientific workflow, the visualization allowing the user to edit the element or the group of elements while working on the scientific workflow; and
creating the visualization of the element or the group of elements of the scientific workflow.

9. The method of claim 8, wherein the visualization comprises an inline editor.

10. A system for visualization of elements of a scientific workflow, the system comprising:
a processor configured to:
define within the scientific workflow, based on predetermined grouping criteria, one or more collapsible groups of elements;
receive, from a user, a request to collapse the one or more collapsible groups of elements;
collapse the one or more collapsible groups of elements into one or more collapsed groups of elements; and
selectively readjust a layout of the plurality of elements and the one or more collapsed groups of elements; and
a user interface configured to display the scientific workflow, the scientific workflow including a plurality of elements.

11. The system of claim 10, further comprising a database configured to store data associated with the scientific workflow.

12. The system of claim 10, wherein the processor is further configured to:
receive a request to add a further element to the scientific workflow;
add the further element to the scientific workflow; and
selectively readjust the layout of the scientific workflow.

13. The system of claim 10, wherein the processor is further configured to:
receive a request to remove a further element from the scientific workflow;
remove the further element to the scientific workflow; and
selectively readjust the layout of the scientific workflow.

14. The system of claim 10, wherein the processor is further configured to:
receive a request to modify a further element of the scientific workflow;
modify the further element to the scientific workflow; and
selectively readjust the layout of the scientific workflow.

15. The system of claim 10, wherein the one or more collapsible groups of elements include one or more of a loop, a conditional statement, a computational tool, a marker, an algorithm, and a nested workflow.

16. The system of claim 10, wherein the plurality of elements comprises one or more of a word, an idea, and a task.

17. The system of claim 10, wherein the processor is further configured to add a space saving element to the layout of the scientific workflow.

18. The system of claim 10, wherein the processor is further configured to:
receive a request to create a visualization of an element or a group of elements of the scientific workflow, the visualization allowing the user to edit the element or the group of elements while working on the scientific workflow; and
create the visualization of the element or the group of elements of the scientific workflow.

19. The system of claim 18, wherein the visualization comprises an inline editor.

20. A non-transitory computer-readable storage medium having embodied thereon a program, the program being executable by a processor to perform a method for visualization of elements of a scientific workflow, the method comprising:
display, via a user interface, the scientific workflow, the scientific workflow including a plurality of elements;
define within the scientific workflow, based on predetermined grouping criteria, one or more collapsible groups of elements;
receive, from a user, a request to collapse the one or more collapsible groups of elements;
collapse the one or more collapsible groups of elements into one or more collapsed groups of elements;
selectively readjust a layout of the plurality of elements and the one or more collapsed groups of elements;
receive a request to add a further element to the scientific workflow;
add the further element to the scientific workflow;
receive a request to remove a further element from the scientific workflow;
remove the further element from the scientific workflow;
receive a request to modify a further element of the scientific workflow;
modify the further element of the scientific workflow;
selectively readjust the layout of the scientific workflow;
add a space saving element to the layout of the scientific workflow;
receive a request to create a visualization of an element or a group of elements of the scientific workflow, the visualization allowing the user to edit the element or the group of elements while working on the scientific workflow; and
create the visualization of the element or the group of elements of the scientific workflow.
